(19) United States
(12) Patent Application Publication
(10) Pub. No.: US 2023/0394327 A1
(43) Pub. Date: Dec. 7, 2023

(54) GENERATING DATASETS FOR SCENARIO-BASED TRAINING AND TESTING OF MACHINE LEARNING SYSTEMS

(71) Applicant: Sage Global Services Limited, Newcastle-Upon-Tyne (GB)

(72) Inventors: Joshua Sean Frazier, Seattle, WA (US); Edolfo Garza-Licudine, San Francisco, CA (US); Jeremiah Edwards, Boulder, CO (US)

(21) Appl. No.: 17/834,817

(22) Filed: Jun. 7, 2022

(51) Int. Cl. G06N 5/02; G06F 11/36

(52) U.S. Cl. CPC G06N 5/022; G06F 11/3612

(57) ABSTRACT

A system and method are described for improved training and testing of machine learning systems by curating user-generated scenarios and using them to validate model behavior post-training. In various embodiments, the system and method generate a dataset that contains records having relevant attribute(s), pattern(s), and/or signal(s) that can be used for model validation and training. Particular datasets that model business-relevant and real-world scenarios are selected and identified, so as to improve the effectiveness of the testing process. The selected data can be used on its own, or it can be used to augment existing training data.

### TECHNICAL FIELD

The present document relates to systems and methods for automatically testing machine learning systems.

### BACKGROUND

Behavioral testing, sometimes referred to as “black-box” testing, is primarily concerned with testing different capabilities of a system by validating its input/output behavior, without any knowledge of the internal structure. For machine learning (ML) systems, behavioral testing is generally conducted by splitting an input data set into training, validation, and testing subsets. The training subset is used to train the ML model. The validation subset is used to check performance of the model fitted on the training subset, while tuning hyperparameters of the model. The testing subset is used to determine the performance of the final trained model, by providing input to the model and then comparing its output to known or expected results.

Such approaches to training ML systems leave a wide gap between what is possible to measure at training time and what the desired behaviors might be. Often, the results of such training methods fail to provide clear data and guidance as to how errors and/or inaccuracies in ML performance can be corrected. In addition, such techniques are typically run statically at training time, therefore failing to provide ongoing, reusable feedback about how a model performs in certain important scenarios. In addition, without the specification of such scenarios, the distribution of training data may not be sufficient for teaching an ML model how to perform in certain special situations.

### SUMMARY

According to various embodiments, a system and method are described for improved training and testing of machine learning systems by curating user-generated scenarios and using them to validate model behavior post-training. In various embodiments, the system and method generate a dataset that contains records having attribute(s), pattern(s), and/or signal(s) relevant to a user-specified scenario, that can be used for model validation and training. By specifying important scenarios in training data, the learned distribution of an ML model can be made to more closely match real-world or desired situations.

A simple example from a sentiment analyzer use case associates the following input strings with the specific expected behavior of the ML engine:
“This application is terrible!”: Output of analysis is that there is negative sentiment toward the product.
“I love this product, highly recommend”: Output of analysis is that there is positive sentiment toward the product.
“This company is terrible; I am glad you are going under!”: Output of analysis is that there is neutral sentiment toward the product.

In each of the above scenarios, a test case depicts output resulting from a particular input string that a practitioner working on a sentiment analysis system has selected to validate a behavior. This list is merely exemplary, and could be extended further as different or more complex behaviors are added to the system.

In at least one embodiment, the system and method described herein select and identify particular datasets that model business-relevant and real-world scenarios, so as to improve the effectiveness of the testing process. The selected data can be used on its own, or it can be used to augment existing training data.

In at least one embodiment, the described system and method also provide a generalized methodology for creating and curating datasets for use in testing ML models. Thus, rather than relying on data in its raw form, which can be insufficient for certain purposes and does not allow for learning or testing on unseen or unknown distributions, the described system and method create and curate datasets that are arbitrary and structured to include particular scenarios that have been identified as particularly relevant for testing modeling behavior.

According to various embodiments, the described system and method allow creation of datasets that have known, arbitrary characteristics, which can in turn allow for more concrete assertions to be made about modeling output, and therefore have higher confidence in the output of the model under known conditions.

The described system and method also allow collected data to be anonymized and augmented as part of the generation of new scenarios. This provides privacy protection for users, while facilitating effective testing that can be used as part of Continuous Integration/Continuous Delivery (CI/CD) processes, based on data that is representative of ground truth data.

Further details and variations are described herein.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1 is a block diagram depicting a hardware architecture for implementing the techniques described herein according to one embodiment.

FIG. 2 is a block diagram depicting a hardware architecture for implementing the techniques described herein in a client/server environment, according to one embodiment.

FIG. 3 is a block diagram depicting an overall software architecture for implementing the system, according to one embodiment.

FIG. 4 is a block diagram depicting exemplary use cases for testing and training machine learning systems using the techniques described herein, according to one embodiment.

FIG. 5 is a block diagram depicting creation of a new scenario based on findings of an investigation, according to one embodiment.

FIG. 6 is a block diagram depicting the functional components of a scenario parser according to one embodiment.

FIG. 7 is a block diagram depicting the functional components of a scenario recorder according to one embodiment.

FIG. 8 is a block diagram depicting an example of a scenario configuration according to one embodiment.

FIG. 9 is a block diagram depicting additional details of an input data configuration according to one embodiment.

FIG. 10 is a block diagram depicting the functional components of a configuration parser according to one embodiment.

FIG. 11 is a flow diagram depicting high level data flow for implementing the techniques described herein, according to one embodiment.

### DETAILED DESCRIPTION OF THE EMBODIMENTS

The systems and methods set forth herein may be applied to many contexts in which it can be useful to identify and segment scenario-based testing and training of machine learning systems. For illustrative purposes, the description herein is set forth with respect to a system implemented using a cloud computing-based architecture. In at least one embodiment, the system can be implemented using various several open source technologies. One of skill in the art will recognize, however, that the systems and methods described herein may be implemented in a wide variety of other contexts, and that they may be implemented using any suitable alternative technology choices.

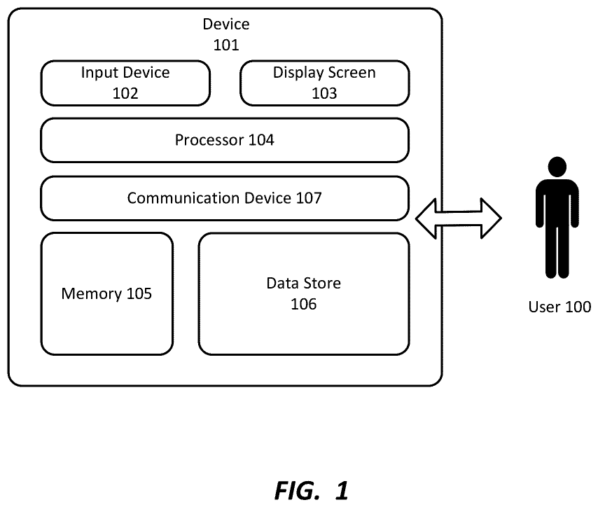

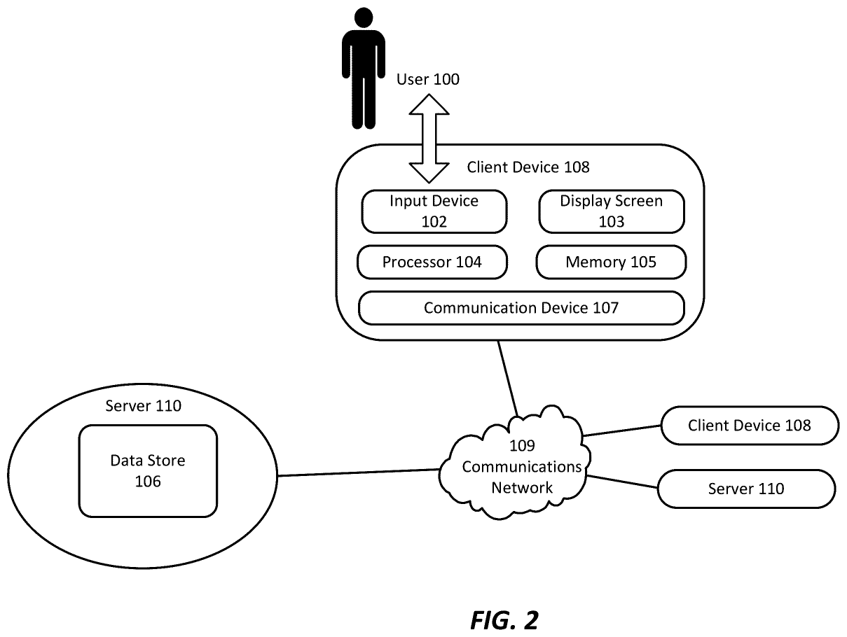

More specifically, in some embodiments, one or more components, as shown and described below in connection with FIGS. 1 and 2, may be used to implement the system and method described herein. In at least one embodiment, such components may be implemented in a cloud computing-based client/server architecture, using, for example, Amazon Web Services, an on-demand cloud computing platform available from Amazon.com, Inc. of Seattle, Washington. Therefore, for illustrative purposes, the system and method are described herein in the context of such an architecture. One skilled in the art will recognize, however, that the systems and methods described herein can be implemented using other architectures, such as for example a standalone computing device rather than a cloud computing-based client/server architecture.

In addition, the particular hardware arrangement depicted and described herein is a simplified example for illustrative purposes.

Further, the functions and/or method steps set forth herein may be carried out by software running on one or more of the device 101, client device(s) 108, server 110, and/or other components. This software may optionally be multi-function software that is used to retrieve, store, manipulate, and/or otherwise use data stored in data storage devices such as data store 106, and/or to carry out one or more other functions.

### Definitions and Concepts

For purposes of the description herein, a “user”, such as user 100 referenced herein, is an individual, company, business, organization, enterprise, entity, or the like, which may optionally include one or more individuals. A “data store”, such as data store 106 referenced herein, is any device capable of digital data storage, including any known hardware for nonvolatile and/or volatile data storage. A collection of data stores 106 may form a “data storage system” that can be accessed by multiple users. A “computing device”, such as device 101 and/or client device(s) 108, is any device capable of digital data processing. A “server”, such as server 110, is a computing device that provides data storage, either via a local data store, or via connection to a remote data store. A “client device”, such as client device 108, is an electronic device that communicates with a server, provides output to a user, and accepts input from a user.

### System Architecture

According to various embodiments, the systems and methods described herein can be implemented on any electronic device or set of intercon-nected electronic devices, each equipped to receive, store, and present information. Each electronic device may be, for example, a server, desktop computer, laptop computer, smartphone, tablet computer, and/or the like. As described herein, some devices used in connection with the systems and methods described herein are designated as client devices, which are generally operated by end users. Other devices are designated as servers, which generally conduct back-end operations and communicate with client devices (and/or with other servers) via a communications network such as the Internet. In at least one embodiment, the techniques described herein can be implemented in a cloud computing environment using techniques that are known to those of skill in the art.

In addition, one skilled in the art will recognize that the techniques described herein can be implemented in other contexts, and indeed in any suitable device, set of devices, or system capable of interfacing with existing enterprise data storage systems. Accordingly, the following description is intended to illustrate various embodiments by way of example, rather than to limit scope.

Referring now to FIG. 1, there is shown a block diagram depicting a hardware architecture for practicing the described system, according to one embodiment. Such an architecture can be used, for example, for implementing the techniques of the system in a computer or other device 101. Device 101 may be any electronic device.

In at least one embodiment, device 101 includes a number of hardware components that are well known to those skilled in the art. Input device 102 can be any element that receives input from user 100, including, for example, a keyboard, mouse, stylus, touch-sensitive screen (touchscreen), touchpad, trackball, accelerometer, microphone, or the like. Input can be provided via any suitable mode, including for example, one or more of: pointing, tapping, typing, dragging, and/or speech. In at least one embodiment, input device 102 can be omitted or functionally combined with one or more other components.

Data store 106 can be any magnetic, optical, or electronic storage device for data in digital form; examples include flash memory, magnetic hard drive, CD-ROM, DVD-ROM, or the like. In at least one embodiment, data store 106 stores information that can be utilized and/or displayed according to the techniques described below. Data store 106 may be implemented in a database or using any other suitable arrangement. In another embodiment, data store 106 can be stored elsewhere, and data from data store 106 can be retrieved by device 101 when needed for processing and/or presentation to user 100. Data store 106 may store one or more data sets, which may be used for a variety of purposes and may include a wide variety of files, metadata, and/or other data.

In at least one embodiment, data store 106 may store data such as training datasets and/or scenarios that are used in testing and training machine learning models. In at least one embodiment, such data can be stored at another location, remote from device 101, and device 101 can access such data over a network, via any suitable communications protocol.

In at least one embodiment, data store 106 may be organized in a file system, using well known storage architectures and data structures, such as relational databases. Examples include Oracle, MySQL, and PostgreSQL. Appropriate indexing can be provided to associate data elements in data store 106 with each other. Scenario data and/or testing datasets can be stored in such databases using any suitable data format(s). In at least one embodiment, data store 106 may be implemented using cloud-based storage architectures such as NetApp (available from NetApp, Inc. of Sunnyvale, California) and/or Google Drive (available from Google, Inc. of Mountain View, California).

Data store 106 can be local or remote with respect to the other components of device 101. In at least one embodiment, device 101 is configured to retrieve data from a remote data storage device when needed. Such communication between device 101 and other components can take place wirelessly, by Ethernet connection, via a computing network such as the Internet, via a cellular network, or by any other appropriate communication systems.

In at least one embodiment, data store 106 is detachable in the form of a CD-ROM, DVD, flash drive, USB hard drive, or the like. Information can be entered from a source outside of device 101 into a data store 106 that is detachable, and later displayed after the data store 106 is connected to device 101. In another embodiment, data store 106 is fixed within device 101.

In at least one embodiment, data store 106 may be organized into one or more well-ordered data sets, with one or more data entries in each set. Data store 106, however, can have any suitable structure. Accordingly, the particular organization of data store 106 need not resemble the form in which information from data store 106 is displayed to user 100 on display screen 103. In at least one embodiment, an identifying label is also stored along with each data entry, to be displayed along with each data entry.

Display screen 103 can be any element that displays information such as text and/or graphical elements. In particular, display screen 103 may present a user interface for testing and training machine learning systems, and/or for viewing the results of such testing and training, as described herein. In at least one embodiment where only some of the desired output is presented at a time, a dynamic control, such as a scrolling mechanism, may be available via input device 102 to change which information is currently displayed, and/or to alter the manner in which the information is displayed.

Processor 104 can be a conventional microprocessor for performing operations on data under the direction of software, according to well-known techniques. Memory 105 can be random-access memory, having a structure and architecture as are known in the art, for use by processor 104 in the course of running software.

A communication device 107 may communicate with other computing devices through the use of any known wired and/or wireless protocol(s). For example, communication device 107 may be a network interface card (“NIC”) capable of Ethernet communications and/or a wireless networking card capable of communicating wirelessly over any of the 802.11 standards. Communication device 107 may be capable of transmitting and/or receiving signals to transfer data and/or initiate various processes within and/or outside device 101.

Referring now to FIG. 2, there is shown a block diagram depicting a hardware architecture in a client/server environment, according to one embodiment. Such an implementation may use a “black box” approach, whereby data storage and processing are done completely independently from user input/output. An example of such a client/server environment is a web-based implementation, wherein client device 108 runs a browser that provides a user interface for interacting with web pages and/or other web-based resources from server 110. Items from data store 106 can be presented as part of such web pages and/or other web-based resources, using known protocols and languages such as Hypertext Markup Language (HTML), Java, JavaScript, and the like.

Client device 108 can be any electronic device incorporating input device 102 and/or display screen 103, such as a desktop computer, laptop computer, personal digital assistant (PDA), cellular telephone, smartphone, music player, handheld computer, tablet computer, kiosk, game system, wearable device, or the like. Any suitable type of communications network 109, such as the Internet, can be used as the mechanism for transmitting data between client device 108 and server 110, according to any suitable protocols and techniques. In addition to the Internet, other examples include cellular telephone networks, EDGE, 3G, 4G, 5G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 108 transmits requests for data via communications network 109, and receives responses from server 110 containing the requested data. Such requests may be sent via HTTP as remote procedure calls or the like.

In one implementation, server 110 is responsible for data storage and processing, and incorporates data store 106. Server 110 may include additional components as needed for retrieving data from data store 106 in response to requests from client device 108.

As described above in connection with FIG. 1, data store 106 may be organized into one or more well-ordered data sets, with one or more data entries in each set. Data store 106, however, can have any suitable structure, and may store data according to any organization system known in the information storage arts, such as databases and other suitable data storage structures. As in FIG. 1, data store 106 may store data such as training datasets and/or scenarios that are used in testing and training machine learning models.

In addition to or in the alternative to the foregoing, data may also be stored in a data store 106 that is part of client device 108. In some embodiments, such data may include elements distributed between server 110 and client device 108 and/or other computing devices in order to facilitate secure and/or effective communication between these computing devices.

As discussed above in connection with FIG. 1, display screen 103 can be any element that displays information such as text and/or graphical elements. Various user interface elements, dynamic controls, and/or the like may be used in connection with display screen 103.

As discussed above in connection with FIG. 1, processor 104 can be a conventional microprocessor for use in an electronic device to perform operations on data under the direction of software, according to well-known techniques. Memory 105 can be random-access memory, having a structure and architecture as are known in the art, for use by processor 104 in the course of running software. A communication device 107 may communicate with other computing devices through the use of any known wired and/or wireless protocol(s), as discussed above in connection with FIG. 1.

In one embodiment, some or all of the system can be implemented as software written in any suitable computer programming language, whether in a standalone or client/server architecture. Alternatively, it may be implemented and/or embedded in hardware.

Notably, multiple servers 110 and/or multiple client devices 108 may be networked together, and each may have a structure similar to those of client device 108 and server 110 that are illustrated in FIG. 2. The data structures and/or computing instructions used in the performance of methods described herein may be distributed among any number of client devices 108 and/or servers 110. As used herein, “system” may refer to any of the components, or any collection of components, from FIGS. 1 and/or 2, and may include additional components not specifically described in connection with FIGS. 1 and 2.

In some embodiments, data within data store 106 may be distributed among multiple physical servers. Thus, data store 106 may represent one or more physical storage locations, which may communicate with each other via the communications network and/or one or more other networks (not shown). In addition, server 110 as depicted in FIG. 2 may represent one or more physical servers, which may communicate with each other via communications network 109 and/or one or more other networks (not shown).

In one embodiment, some or all components of the system can be implemented in software written in any suitable computer programming language, whether in a standalone or client/server architecture. Alternatively, some or all components may be implemented and/or embedded in hardware.

### Software Architecture

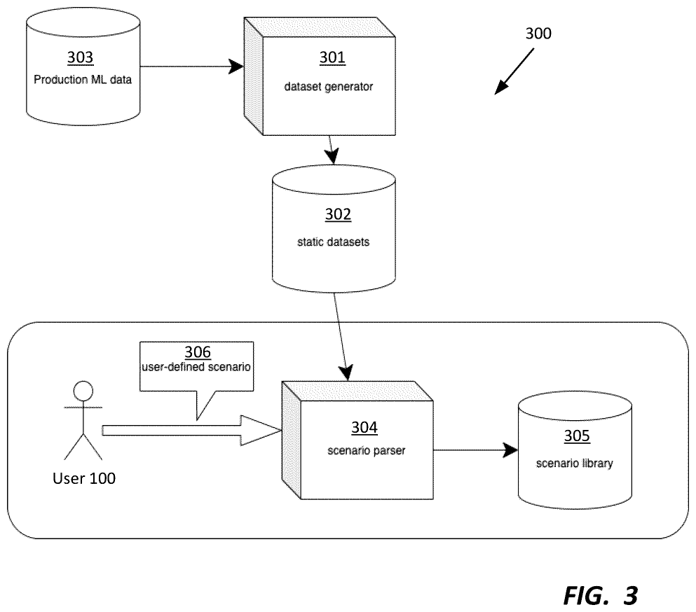

Referring now to FIG. 3, there is shown a block diagram depicting an overall software architecture 300 for implementing the system described herein, according to one embodiment. In at least one embodiment, the software architecture of FIG. 3 can be implemented using hardware components as depicted in FIGS. 1 and/or 2. However, one skilled in the art will recognize that software architecture 300 can be implemented using other hardware components and arrangements. The components and arrangement depicted in FIG. 3 thus represent one possible architecture for implementing the system and method described herein for generating and curating scenarios that can be used for testing and training ML systems. As described herein, the scenarios generated by the described system can be used by both human ML practitioners and automated model validation systems such as are used in Continuous Integration/Continuous Delivery (CI/CD) deployments.

Dataset generator 301 generates static datasets 302 based on production ML data 303. These datasets contain arbitrary views, which may be aggregations or subsets of raw data, based on the nature of the scenario being recorded, and used as the source data for the scenario being recorded. User 100, who may be a data scientist or ML engineer, for example, specifies a scenario 306. Scenario parser 304 extracts appropriate data from datasets 302, based on user-defined scenario 306, to generate and store particulars of the scenario in scenario library 305. In this manner, an expert data scientist or ML engineer can access and create or generate such testing scenarios in order to achieve a specific modeling outcome, thereby automating the generation of behavior testing scenarios.

In at least one embodiment, any number of data stores, such as data store 106 shown in FIGS. 1 and 2, can be used for storing production ML data 303, static datasets 302, and/or scenario library 305. In at least one embodiment, ML data 303, static datasets 302, and/or scenario library 305 are implemented using Apache Parquet. In at least one embodiment, a self-descriptive serialization protocol is used, which allows user 100 to specify scenario 306 based on desired properties of dataset 302 without querying the data itself.

In at least one embodiment, scenario parser 304 is implemented as a distributed, parallelizable processing application which can scan and process data using multiple independent workers. In at least one embodiment, scenario parser 304 is implemented as a Python application, running in one or more Docker containers as part of an Argo workflow on Kubernetes, an open source container orchestration system.

In at least one embodiment, scenario library 305 as generated by scenario parser 304 is partitioned and stored in any suitable blob storage technology, such as for example AWS S3 (Amazon Simple Storage Service) cloud storage, available from Amazon.com, Inc. of Seattle, Washington.

### Scenario Parser 304

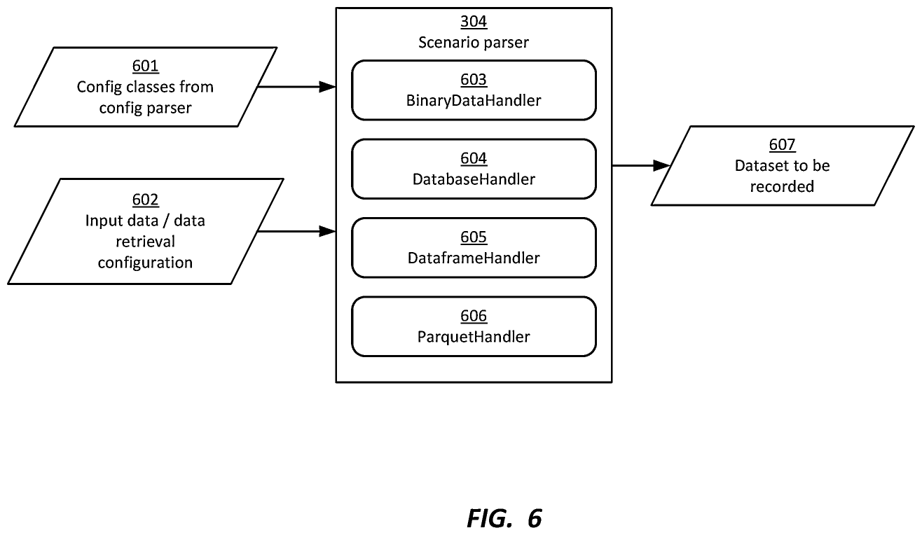

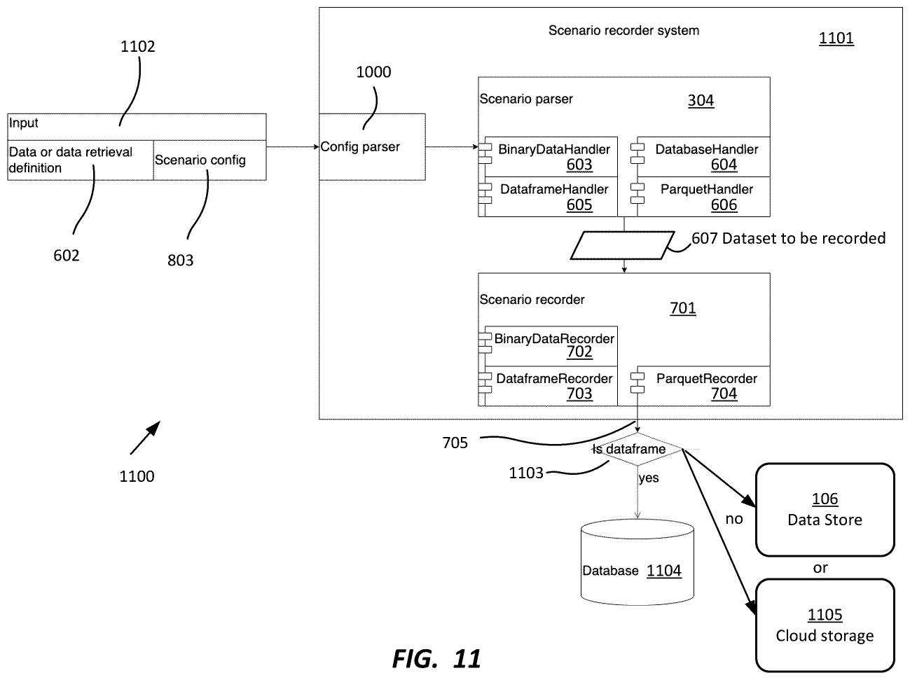

Referring now to FIG. 6, there is shown a block diagram depicting the functional components of scenario parser 304 according to one embodiment. The data received at scenario parser 304 includes configuration classes 601 from configuration parser 1100 (discussed below in connection with FIG. 11) and data or data retrieval definition 602. Scenario parser 304 includes various handlers for handling various types of input data; these may include any suitable data de-serialization techniques commonly used in machine learning applications, such as for example:
binary data handler 603 for handling binary data;
database handler 604 for handling databases;
dataframe handler 605 for handling dataframes; and
parquet handler 606 for handling parquet files.

Using these various handlers 603, 604, 605, 606, scenario parser 304 generates dataset 607 to be recorded by scenario recorder 701 as discussed in more detail below.

### Scenario Recorder 701

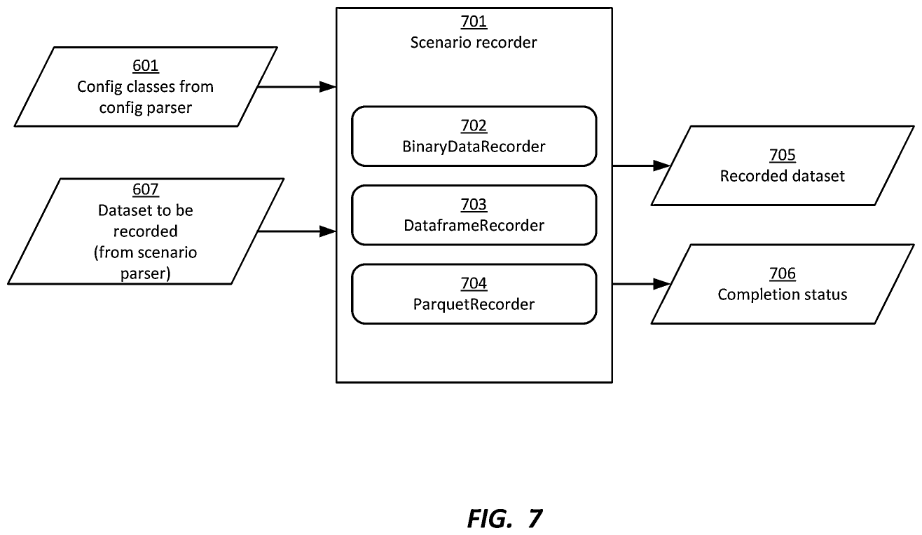

Referring now to FIG. 7, there is shown a block diagram depicting the functional components of scenario recorder 701 according to one embodiment. The data received at scenario recorder 701 includes configuration classes 601 from configuration parser 1100 (discussed below in connection with FIG. 11) and dataset 607 from scenario parser 304. Scenario recorder 701 includes various recorders for recording various elements of the scenario; these may include any suitable data de-serialization techniques commonly used in machine learning applications, such as for example:
binary data recorder 702 for recording binary data;
dataframe recorder 703 for recording dataframes; and
parquet recorder 704 for recording parquet files.

Using these various recorders 702, 703, 704, scenario recorder 701 generates recorded dataset 705 and issues completion status 706 indicating current status of the recording operation.

### Configuration Parser 1000

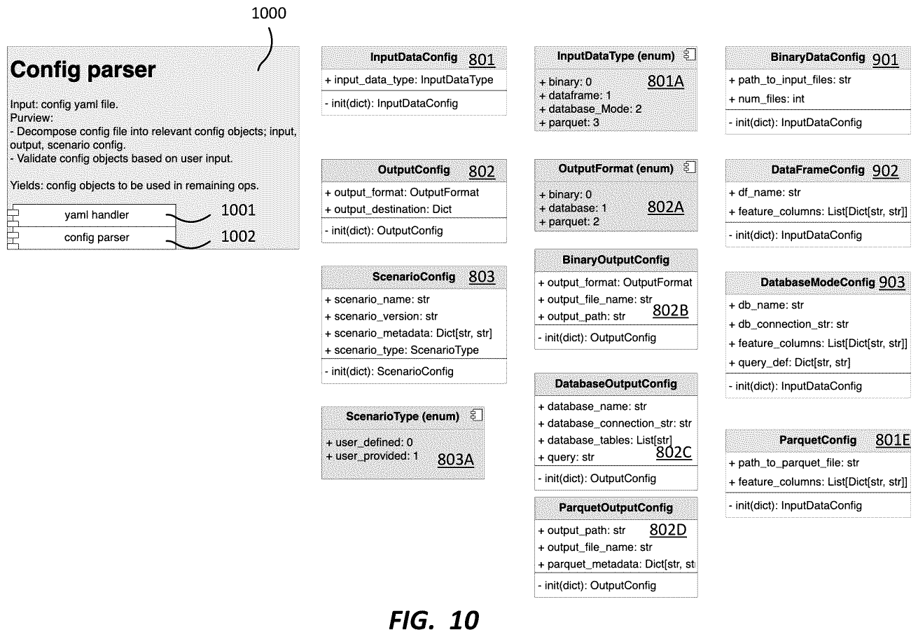

Referring now to FIG. 10, there is shown a block diagram depicting the functional components of configuration parser 1000 according to one embodiment.

In at least one embodiment, configuration parser 1000 takes as input a YAML configuration file, decomposes the configuration file into relevant configuration objects (including input, output, and scenario configurations), and validates these configuration objects based on user input. Output of configuration parser 1000 is a set of configuration objects that can be used by other components.

In at least one embodiment, configuration parser 1000 may include two modules: YAML handler 1001 that handles YAML file input and yields dictionaries; and configuration parser module 1002 that that uses those dictionaries to construct the appropriate class objects.

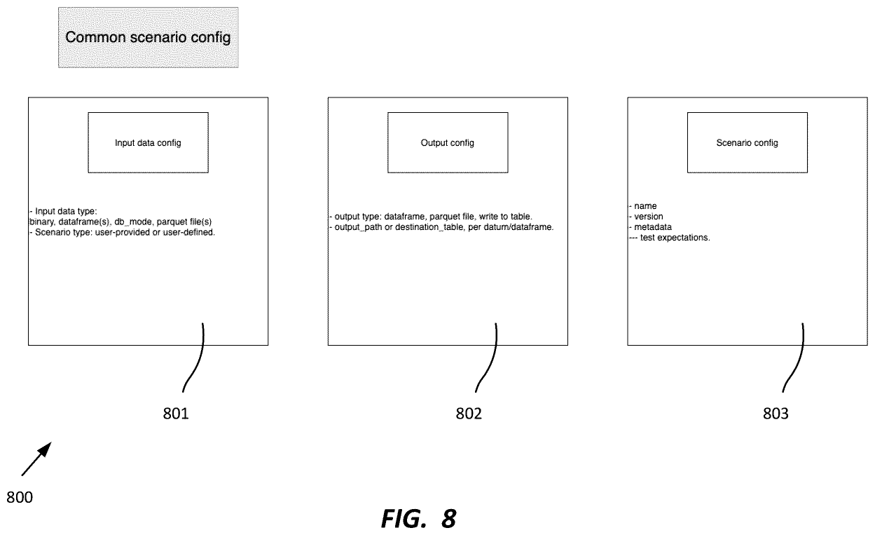

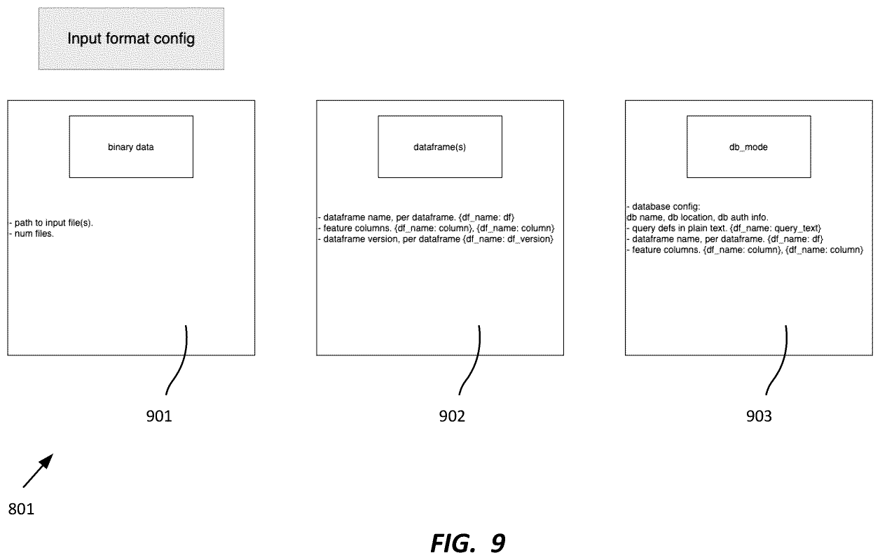

FIG. 10 also depicts various configuration files that may be used by configuration parser 1000, as described in more detail below in connection with FIGS. 8 and 9. These include, for example:
input data configuration 801;
input data type 801A;
binary data configuration 901;
dataframe configuration 902;
database mode configuration 903;
parquet configuration 801E;
output configuration 802;
output format 802A;
binary output configuration 802B;
database output configuration 802C;
parquet output configuration 802D;
scenario configuration 803; and
scenario type 803A.

### Scenario Generation

In at least one embodiment, scenarios are generated via a software tool that is implemented using python dictionaries. User 100 defines desirable attributes of the data to be generated, and components described herein translate the user-defined configuration into an appropriate data format, such as for example, pandas data frames, which is a well known in-memory data storage and manipulation mechanism.

In at least one embodiment, code implementing the described system may be output as a stand-alone python library, which can be imported into any python script or application context as appropriate.

In at least one embodiment, the scenario recording system described herein can be implemented using a combination of existing technologies. For example, the following technologies may be used for implementing the various functionality described herein:
Data augmentation: Pandas, NumPy
Data storage: Parquet, Postgres database
Configuration: YAML
Containerization: Docker
Deployment orchestration: Kubernetes, via terraform.
Language: Python3
Scheduler/workflow orchestration: Argo

One skilled in the art will recognize that these tools and technologies are merely exemplary, and that the systems and methods described herein can be implemented using other tools and technologies.

### Output

In at least one embodiment, the system generates output that can be used in multiple ways, including for example output that can be used for experimentation, user behavior validation, and/or the like.

### Input Data Types

In at least one embodiment, the system is configured to support at least the following input data types:
Binary data: Examples include images such as PDFs, JPEGs, and/or the like. One example of a use case for such input data is optical character recognition (OCR) of invoice images. Such data can be passed to the scenario recorder system, for example, by specifying path(s) to the file(s) in a config file.
Dataframe: This reflects the Python standard for in-memory structured data. Such data can be passed to the scenario recorder system, for example, by reference within the config file.
Database mode: In at least one embodiment, the system can be configured to access a database based on the location of the database. Specific table(s) can be specified, as well as the queries to be run that can yield the desired dataset. Such data can be passed to the scenario recorder system, for example, by reference within the config file.
Parquet: In at least one embodiment, this type of data can be passed to the scenario recorder system by specifying the location of parquet files. In at least one embodiment, retrieval semantics may also be provided, such as how to access data, how to pull in metadata, and/or the like.

### Configuration Specification

Referring now to FIG. 8, there is shown a block diagram depicting an example of a scenario configuration 800 according to one embodiment. In at least one embodiment, the depicted configuration is used to specify certain desirable attributes of the scenario. The configuration can be expressed, for example, in YAML files. It can also be used to apply metadata about data being captured (for user-provided data) or generated (for user-defined defined).

In at least one embodiment, scenario configuration 800 can be specified via a series of classes that represent various configuration sub-sections as data classes.

As shown in FIG. 8, scenario configuration 800 can specify, for example:
input data configuration 801, including an input data type (binary, dataframe(s), database mode, and/or parquet file(s)) and a scenario type (user-provided or user-defined);
output configuration 802, including an output type (dataframe parquet file, or write to table) and an output path or destination table for each datum or dataframe; and
scenario configuration 803, including name, version, metadata, and/or test expectations.

Referring now to FIG. 9, there is shown a block diagram depicting additional details of input data configuration 801 according to one embodiment. In at least one embodiment, the depicted configuration is used to specify an input format for the scenario.

As shown in FIG. 9, input data configuration 801 can specify, for example:
binary data configuration 901, including for example a path to input file(s) and the number of files;
dataframe(s) configuration 902, including names, feature columns, and dataframe version for each dataframe;
database mode configuration 903, including database name, location, and authorization information; query definitions; dataframe names; and feature columns.

### Data Flow

Referring now to FIG. 11, there is shown a flow diagram depicting high level data flow 1100 for implementing the techniques described herein, according to one embodiment.

Scenario recorder system 1101 includes configuration parser 1100, scenario parser 304, and scenario recorder 701, as discussed above. Configuration parser 1100 receives input 1102 including, for example, data or data retrieval definition 602 and scenario configuration 803. Configuration parser 1100 parses the received input, and forwards the output to scenario parser 304. As discussed above in connection with FIG. 6, scenario parser 304 uses various handlers 603, 604, 605, 606, to generate dataset 607 to be recorded by scenario recorder 701.

As discussed above in connection with FIG. 7, scenario recorder 701 uses various recorders 702, 703, 704, to generate recorded dataset 705.

In at least one embodiment, handling of recorded dataset 705 may differ based on the type of data input. For example, in at least one embodiment:
Data frames that are to be persisted are stored in database 1104 according to a specified configuration that indicates table(s) where the data frames are to be written.
Binary data (such as images and the like) are not mutable. In general, binary data represents user-provided datasets; in at least one embodiment, they are stored in cloud storage 1105 (such as Amazon Simple Storage Service, or S3) or on a local file system such as data store 106.
Parquet files are stored, along with metadata, in cloud storage 1105 (such as S3) or on a local file system such as data store 106, depending on the configuration.

A determination is made 1103 as to whether recorded dataset 705 is a dataframe (tabular data). If so, it may be stored in database 1104. Otherwise, it may be stored in file system 1105, which may be implemented for example using S3.

One skilled in the art will recognize that other distinctions can be made based on the type of input data and its configuration.

### Method

In at least one embodiment, the system curates user-defined scenarios and uses them to validate model behavior post-training.

In at least one embodiment, a native client installed on user's 100 machine captures activities performed by user 100. Data concerning such activities is collected, and like computer activities are clustered with one another. In this manner, captured activities are categorized. In at least one embodiment, such data may be anonymized so as to preserve privacy.

In at least one embodiment, the process of clustering and categorizing activities is performed using machine learning. The machine learning processes can be tested using the techniques described herein. In at least one embodiment, the system can capture user-created scenarios as well as user-defined scenarios, so that it is able to define a data set that approximates actual user activities without having to capture information about such activities in the field.

In at least one embodiment, an Argo workflow is run on the machine learning system to be tested. The dataset to be used for testing is defined, and scenario metadata is also defined. The dataset and metadata are provided to the machine learning system, where it is stored in a persistent manner, for example in a database.

In at least one embodiment, the system can capture datasets for any number of systems, so as to improve testing of multiple machine learning systems. Data from different systems may be used to improve the performance of other systems.

### Data Sources

In at least one embodiment, data scenarios are derived from actual real-world data, also referred to as “production data” or “production machine learning data.” Production data may include real-world datasets that have been identified as inherently including attributes that are interesting, useful, and/or desirable for use with the scenario system described herein.

In at least one alternative embodiment, data scenarios may use syn-thetically derived data, also referred to as “synthetic data.” Synthetic data may include arbitrary attributes that are interesting, useful, and/or desirable for use with the scenario system described herein.

In yet another embodiment, data scenarios may be derived from a combination of production data and synthetic data.

Any of a number of mechanisms may be used to generate synthetic data for use with the described system. Such mechanisms may include, for example, manual generation by a human, machine-learning based generation, parametric generation, and/or the like. In general, however, regardless of the mechanism used to generate synthetic data, such data can be used in connection with the scenario system described herein in the same manner as described for production data.

Manual synthetic data generation. In at least one embodiment, an expert in the art of software development and in the datasef s domain can craft datasets with desired attributes. This can be done programmatically, for example, by building software systems capable of mimicking data models.

Machine learning-based synthetic data generation. In at least one embodiment, a generative adversarial network (GAN) or other technique can be used to employ multi-neural network architectures for generating datasets. Once datasets have been generated, they can be automatically evaluated for accuracy or correctness in view of the goals to be accomplished via scenario generation. In at least one embodiment, an expert in the art of neural network architectures and development can build and train such a system.

Parametric synthetic data generation. In at least one embodiment, an expert in the art of machine learning can build and train a system designed to optimize selection and prediction of specific parameters in the process of generating the dataset. The data can then be generated automatically, according to the specified parameters.

### Use Cases

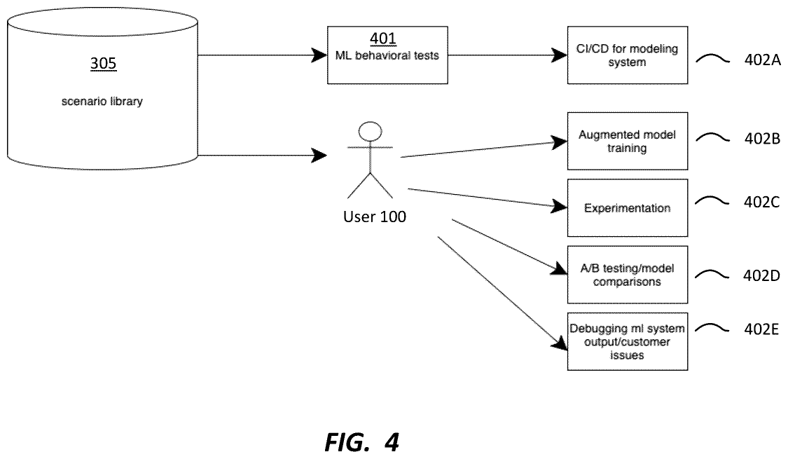

Referring now to FIG. 4, there is shown a block diagram depicting exemplary use cases for testing and training machine learning systems using the techniques described herein, according to one embodiment. Machine learning behavioral tests 401 are applied using data from scenario library 305, to generate output used by Continuous Integration/Continuous Delivery (CI/CD) deployments 402A for a modeling system. In the depicted example, a new ML model is undergoing testing prior to promotion, deployment, and use by end users or cus-tomers. Prior to the promotion process, the model is integrated with the production runtime system, and the entire system is verified to ensure that it behaves correctly in certain business-critical scenarios. The enumeration of critical scenarios in this system can be leveraged in such a CI process as test cases of correct behavior.

User 100, who may be a data scientist or ML engineer, for example, accesses scenario library 305 to support any number of use cases and tasks, such as for example, augmented model training 402B, experimentation 402C, A/B testing/model comparisons 402D, and/or debugging ML system output and/or customer issues 402E.

In at least one embodiment, the examples depicted in items 402A through 403E are components of a data science model development workflow being performed by user 100. Items 402A through 403E are depicted herein to illustrate examples by which scenario library 305 can be integrated into both the automated and manual model development processes.

Machine learning behavioral tests 401 are applied using data from scenario library 305, to generate output used by Continuous Integration/Continuous Delivery (CI/CD) deployments 402A for a modeling system. User 100, who may be a data scientist or ML engineer, for example, accesses scenario library 305 to support any number of use cases and tasks, such as for example, augmented model training 402B, experimentation 402C, A/B testing/model comparisons 402D, and/or debugging ML system output and/or customer issues 402E.

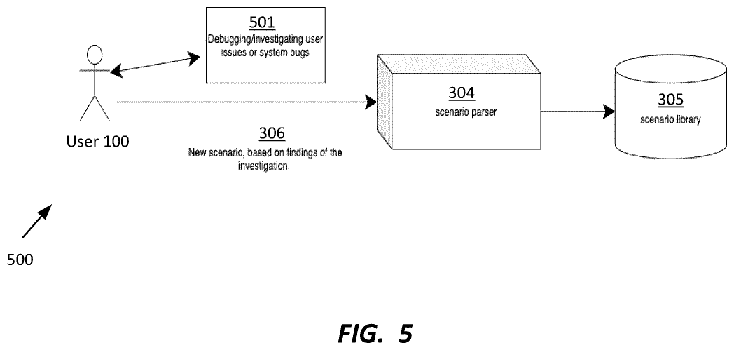

Referring now to FIG. 5, there is shown a block diagram depicting a specific use case 500 in which a new scenario is created based on findings of an investigation, according to one embodiment. User 100, who may be a data scientist or ML engineer, for example, is engaged in the process 501 of debugging or investigating user issues and/or system bugs. In the course of such operations, user 100 defines a new scenario 306, based on the findings of his or her investigation. This new scenario 306 may be of particular relevance in testing the machine learning system. As described above in connection with FIG. 3, scenario parser 304 extracts appropriate data based on user-defined scenario 303, to generate and store particulars of the scenario in scenario library 305. In this manner, an expert data scientist or ML engineer can influence testing so that it is particularly relevant in view of user's 100 current area of focus in debugging or investigating issues.

### Advantages

Various embodiments of the described system and method provide techniques for creating datasets that have known, arbitrary characteristics, which can in turn allow for more concrete assertions to be made about modeling output, and therefore have higher confidence in the output of the model under known conditions. In addition, the described system and method provide an ex-tensible framework for adding new scenarios as they are identified, so that tests can be conducted as part of a Continuous Integration/Continuous Delivery (CI/CD) process. In this manner, updates can be installed with assurance that they will not break core behavior and functionality. The described system and method also facilitate experimentation and testing of new models to compare against existing ones.

The system and method described herein may also provide additional functionality, including:
Providing a mechanism to develop a taxonomy of datasets;
Expressing the taxonomy as metadata, which can be stored along with the dataset for use by humans and machines;
Making the datasets and their metadata available for various use cases, including those described herein; and
Making storage of the datasets consistent, by providing and enforcing consistent conventions and storage processes.

### Data Privacy

In some use cases, it may be desirable to augment or obfuscate certain features of a given dataset.

The described system and method also allow collected data to be anonymized and augmented as part of the generation of new scenarios. This provides privacy protection for users, while facilitating effective testing that can be used as part of CI/CD processes, based on data that is representative of ground truth data.

More specifically, in at least one embodiment, the system and method provide the ability to perform augmentation as an optional processing step, for example performed by scenario parser 304.

In at least one embodiment, data augmentation is performed for certain data types only, for example excluding binary data such as images and the like. In at least one embodiment, data augmentation can be configured via the configuration interface described herein. One example of a configuration for data augmentation is as follows:

{<dataframe/db table/parquet table>:{<column_to_be_augmented>:<augmentation method>}}

where augmentation method may be a member of a set of pre-defined and programmed methods for augmenting data. The type of augmentation to be applied may depend on the data type (e.g., string vs. integer) held by the column in question, and the nature of the data contained there (e.g., name vs. Address vs. Age, or the like).

The configuration design allows users to express their data augmentation desires on a per-data and/or per-column basis, so that multiple tables and columns can be augmented as desired, and on a case-by-case basis.

One skilled in the art will recognize that the examples depicted and described herein are merely illustrative, and that other arrangements of user interface elements can be used. In addition, some of the depicted elements can be omitted or changed, and additional elements depicted, without departing from the essential characteristics.

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions can be embodied in software, firmware and/or hardware, and when embodied in software, can be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the described system and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corpo-ration of Redmond, Washington; Mac OS X, available from Apple Inc. of Cupertino, California; iOS, available from Apple Inc. of Cupertino, California; Android, available from Google, Inc. of Mountain View, California; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A computer-implemented method for generating datasets for scenario-based training and testing of a machine learning system, comprising:
automatically generating a plurality of initial datasets based on at least one of production data and synthetic data;
receiving user input specifying a scenario;
automatically extracting data relevant for the user-specified scenario from the datasets;
automatically generating a scenario library based on the extracted data; and
storing the generated scenario library for use in testing the machine learning system.

2. The method of claim 1, wherein generating a plurality of initial datasets comprises:
collecting data describing user activities; and
categorizing the collected data.

3. The method of claim 2, further comprising anonymizing the collected data.

4. The method of claim 1, further comprising parsing the received user input specifying a scenario to generate a dataset to be recorded.

5. The method of claim 4, wherein automatically generating a scenario library based on the extracted data comprises recording at least one scenario based on the parsed user input.

6. The method of claim 5, wherein recording at least one scenario comprises recording at least one of the group consisting of:
binary data;
dataframes; and
Parquet files.

7. A non-transitory computer-readable medium for scenario-based training and testing of a machine learning system, comprising instructions stored thereon, that when performed by a hardware processor, perform the steps of:
automatically generating a plurality of initial datasets based on at least one of production data and synthetic data;
causing an input device to receive user input specifying a scenario;
automatically extracting data relevant for the user-specified scenario from the datasets;
automatically generating a scenario library based on the extracted data; and
causing an electronic storage device to store the generated scenario library for use in testing the machine learning system.

8. The non-transitory computer-readable medium of claim 7, wherein generating a plurality of initial datasets comprises:
collecting data describing user activities; and
categorizing the collected data.

9. The non-transitory computer-readable medium of claim 8, further comprising instructions stored thereon, that when performed by a hardware processor, perform the step of anonymizing the collected data.

10. The non-transitory computer-readable medium of claim 7, further comprising instructions stored thereon, that when performed by a hardware processor, perform the step of parsing the received user input specifying a scenario to generate a dataset to be recorded.

11. The non-transitory computer-readable medium of claim 10, wherein automatically generating a scenario library based on the extracted data comprises recording at least one scenario based on the parsed user input.

12. The non-transitory computer-readable medium of claim 11, wherein recording at least one scenario comprises recording at least one of the group consisting of:
binary data;
dataframes; and
Parquet files.

13. A system for generating datasets for scenario-based training and testing of a machine learning system, comprising:
an input device, configured to receive user input specifying a scenario;
a hardware processor, communicatively coupled to the input device, configured to:
automatically generate a plurality of initial datasets based on at least one of production data and synthetic data;
automatically extract data relevant for the user-specified scenario from the datasets; and
automatically generate a scenario library based on the extracted data; and
an electronic storage device, communicatively coupled to the hardware processor, configured to store the generated scenario library for use in testing the machine learning system.

14. The system of claim 13, wherein generating a plurality of initial datasets comprises:
collecting data describing user activities; and
categorizing the collected data.

15. The system of claim 14, further comprising anonymizing the collected data.

16. The system of claim 13, further comprising parsing the received user input specifying a scenario to generate a dataset to be recorded.

17. The system of claim 16, wherein automatically generating a scenario library based on the extracted data comprises recording at least one scenario based on the parsed user input.

18. The system of claim 17, wherein recording at least one scenario comprises recording at least one of the group consisting of:
binary data;
dataframes; and
Parquet files.
